(19) United States
(12) Patent Application Publication
(10) Pub. No.: US 2022/0230038 A1
(43) Pub. Date: Jul. 21, 2022

(54) SELF-ADHESIVE STRAPS FOR RFID DEVICES

(71) Applicant: Avery Dennison Retail Information Services LLC, Mentor, OH (US)

(72) Inventors: Ian FORSTER, Chelmsford (GB); Edward McGINNISS, Clinton, SC (US)

(21) Appl. No.: 17/605,421

(22) PCT Filed: Apr. 22, 2020
(86) PCT No.: PCT/US2020/029284

§ 371 Date: Oct. 21, 2021

Related U.S. Application Data
(60) Provisional application No. 62/836,900, filed on Apr. 22, 2019.

(51) Int. Cl. G06K 19/077

(52) U.S. Cl. CPC G06K 19/07752; G06K 19/07773

(57) ABSTRACT

An RFID device includes an antenna defining a gap, with an RFID strap electrically coupled to the antenna across the gap. The RFID strap is secured to the antenna by a self-adhesive substance, such as a pressure-sensitive adhesive, an isotropic conductive adhesive, or an anisotropic conductive adhesive. The use of a self-adhesive substance allows for such an RFID device to be assembled at facilities other than dedicated RFID device manufacturing facilities, which may include a packaging supplier factory. Additionally, such an RFID device allows for the creation of a flexible “build on demand” system capable of producing a smaller number of RFID devices than are typically produced using conventional approaches. Such a system may further test, program, apply print to, and/or cut an RFID device that it has assembled.

### CROSS REFERENCE TO RELATED APPLICATION

The present application claims priority to and the benefit of United States provisional utility patent application No. 62/836,900 filed Apr. 22, 2019, which is incorporated herein by reference in its entirety.

### FIELD OF THE DISCLOSURE

The present subject matter relates to radio frequency identification (“RFID”) devices. More particularly, the present subject matter relates to self-adhesive RFID straps and techniques for mounting such RFID straps to antennas.

### BACKGROUND

RFID tags and labels (collectively referred to herein as “devices”) are widely used to associate an object with an identification code. RFID devices generally have a combination of antennas and analog and/or digital electronics, which may include, for example, communications electronics, data memory, and control logic. For example, RFID tags are used in conjunction with security locks in cars, for access control to buildings, and for tracking inventory and parcels.

One difficulty associated with manufacturing RFID devices is the need to assemble them in dedicated RFID device manufacturing facilities. This is due, in part, to the manner in which the antenna of such a device is secured to the other components of the device. For example, in one approach, an antenna and a separate RFID strap (which includes an RFID chip) are provided. An adhesive is applied to pads of the antenna, followed by the RFID strap being placed into contact with the adhesive. The adhesive is then cured to secure the RFID strap to the antenna. The properties of the adhesive are critical to the function and parameters of the RFID device (e.g., the minimum power at which the device can respond to a reader system and the frequency at which the device is configured to optimally operate), which requires advanced manufacturing facilities to achieve the required control. As such, RFID devices of this type may only be manufactured and assembled at specialized facilities.

For convenience, an RFID manufacturing factory or facility may be positioned in the vicinity of a factory or facility of a product manufacturer that acquires the RFID devices from the RFID manufacturing facility for incorporation into its products. So locating the two factories reduces the costs for shipping the RFID devices from the RFID manufacturer to the product manufacturer. However, if the product manufacturer move its factory or facility to another location (e.g., to a different country, due to manufacturing cost considerations), the costs of shipping the RFID devices from the factory or facility of the RFID manufacturer to the new location could be significantly increased, along with an increased environmental impact.

Additionally, an RFID manufacturer may prefer to create RFID devices in a large quantity, due to economies of scale. As a result, the number of RFID devices preferred to be made by the RFID manufacturer may be greater than the number required by a customer.

Therefore, there exists a need for an RFID device that may be assembled at a factory or facility other than a dedicated RFID device manufacturing factory or facility. There also exists a need for an RFID device that may be more simply assembled, allowing for (preferably portable) “build on demand” systems capable of producing a smaller number of RFID devices than are typically produced using conventional approaches.

Accordingly, it is an object of the present disclosure to provide an RFID device that may be assembled at a factory or facility other than a dedicated RFID device manufacturing factory or facility. It is also an object of the present disclosure to provide an RFID device that may be more simply assembled, allowing for (preferably portable) “build on demand” systems capable of producing a smaller number of RFID devices than are typically produced using conventional approaches.

### SUMMARY

There are several aspects of the present subject matter which may be embodied separately or together in the devices and systems described and claimed below. These aspects may be employed alone or in combination with other aspects of the subject matter described herein, and the description of these aspects together is not intended to preclude the use of these aspects separately or the claiming of such aspects separately or in different combinations as may be set forth in the claims appended hereto.

RFID devices including an antenna defining a gap and an RFID strap electrically coupled to the antenna across the gap, and methods of making and using thereof, are described herein.

In some embodiments, the RFID strap is secured to the antenna by a self-adhesive substance or material. In some embodiments, the self-adhesive substance or material contains, or is, a pressure-sensitive adhesive, an isotropic conductive adhesive, such as a paste or film, or an anisotropic conductive adhesive, such as a paste or film.

Methods of assembling an RFID device are also described. In some embodiments, the method includes providing an antenna and an RFID strap. The method further includes securing the RFID strap to the antenna using a self-adhesive substance, as described above, so as to electrically couple the RFID strap to the antenna across a gap defined by the antenna.

Systems for assembling the RFID devices are described herein. In some embodiments, the system for assembling an RFID device includes an antenna creation station configured to form an antenna defining a gap. In some embodiments, the system includes an antenna creation station as described above and a strap attach station configured to electrically couple an RFID strap to the antenna across the gap, with the RFID strap being secured to the antenna by a self-adhesive substance or material as described above. In some embodiments, the system includes the creation attachments stations described above and further includes a testing station configured to test the performance of an RFID device assembled by the system. In still other embodiments, the system contains the creation, attachment, and testing stations as described above, and further includes a programming station configured to program an RFID chip of an RFID device assembled by the system. The systems described above can further include a printing station configured to apply human-readable indicia to an RFID device assembled by the system and/or a cutting station configured to cut a portion of an RFID device assembled by the system. The various stations described above can be located at one location, e.g., within one facility, or at multiple locations or within multiple facilities at the same locations.

### BRIEF DESCRIPTION OF THE DRAWINGS

FIG. 1 is a diagrammatic, side elevational view of an antenna of an RFID device according to the present disclosure;

FIG. 1A is a diagrammatic, top plan view of the antenna of FIG. 1;

FIG. 2 is a diagrammatic, side elevational view of the antenna of FIG. 1 and an RFID strap to be secured to the antenna using a self-adhesive substance;

FIG. 3 is a diagrammatic, side elevational view of the antenna and RFID strap of FIG. 2 secured together to define an RFID device;

FIG. 3A is a diagrammatic, top plan view of the RFID device of FIG. 3;

FIG. 4 is a diagrammatic, side elevational view of the RFID strap of FIG. 2, provided with a first exemplary self-adhesive substance;

FIG. 5 is a diagrammatic, side elevational view of the RFID strap of FIG. 2, provided with a second exemplary self-adhesive substance;

FIG. 6 is a diagrammatic, side elevational view of the RFID strap of FIG. 2, provided with a third exemplary self-adhesive substance; and

FIG. 7 is a diagrammatic illustration of a “build on demand” system for manufacturing RFID devices according to the present disclosure.

### DESCRIPTION OF THE ILLUSTRATED EMBODIMENTS

As required, detailed embodiments of the present invention are disclosed herein; however, it is to be understood that the disclosed embodiments are merely exemplary of the invention, which may be embodied in various forms. Therefore, specific details disclosed herein are not to be interpreted as limiting, but merely as a basis for the claims and as a representative basis for teaching one skilled in the art to variously employ the present invention in virtually any appropriate manner.

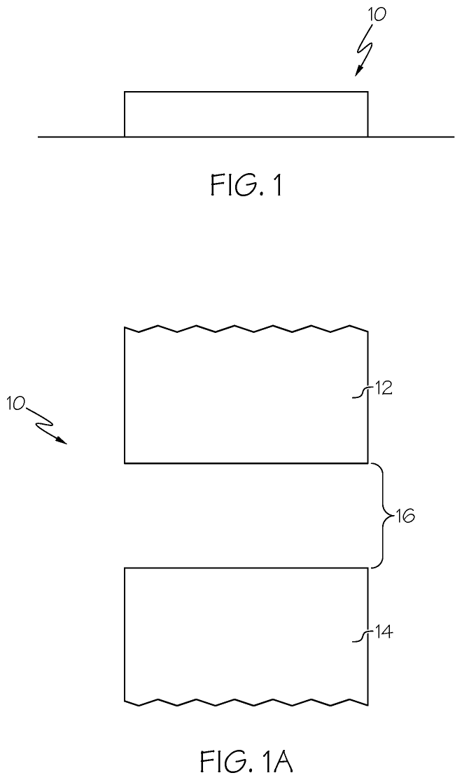

FIG. 1 illustrates an antenna 10 of the type that may be incorporated into the RFID devices described herein. The antenna 10 may be variously manufactured and configured without departing from the scope of the present disclosure. However, in one embodiment, the antenna is configured in a conventional manner, with a pair of pads 12 and 14 separated by a gap 16 (FIG. 1A).

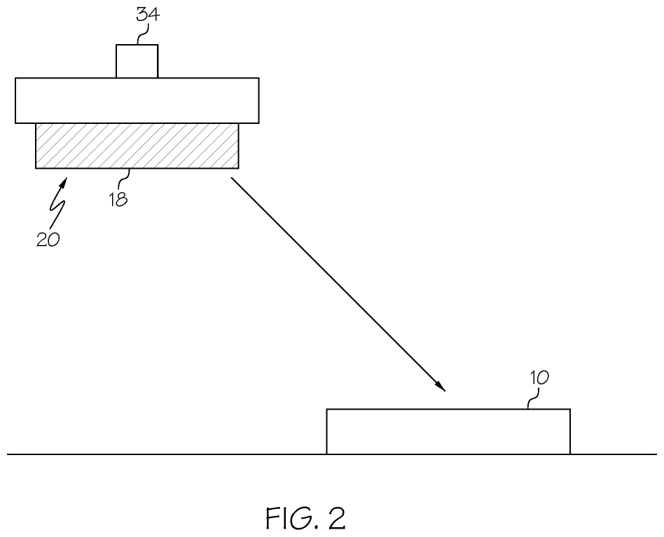

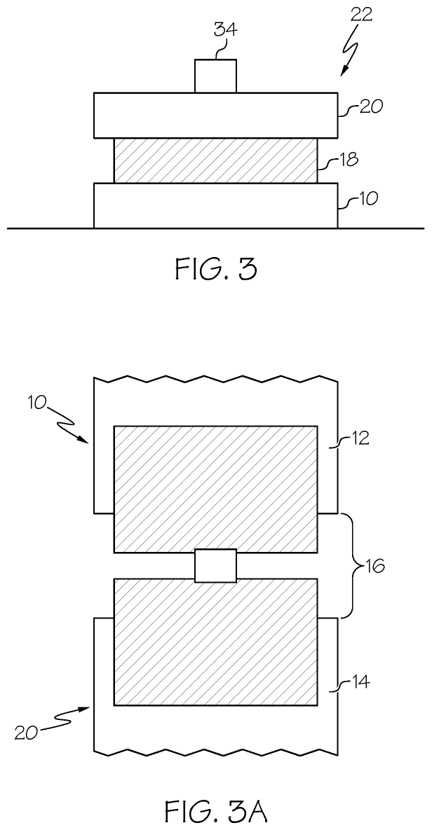

Rather than an adhesive being applied to the pads 12 and 14 (as in a conventional approach), a self-adhesive substance or material 18 having defined characteristics (e.g., thickness and the real and imaginary part of the dielectric constant) is applied to an RFID strap 20 (FIG. 2) to be secured to the antenna 10 to define an RFID device 22 (FIGS. 3 and 3A). The self-adhesive substance or material 18 is configured to adhere to the antenna 10 to secure the RFID strap 20 (such as pads of the RFID strap 20) to the antenna 10 (with the RFID strap 20 electrically coupled to the antenna 10 across the gap 16, as shown in FIG. 3A) without requiring a separate curing procedure (as is required in conventional approaches). While FIG. 2 shows the self-adhesive substance or material 18 applied to the RFID strap 20, it should be understood that the self-adhesive substance 18 may instead be applied to the antenna 10 or to both the antenna 10 and the RFID strap 20. In yet another embodiment, a first substance may be applied to the antenna 10 and a second substance may be applied to the RFID strap 20, with the two substances combining (when placed into contact with each other) to produce a self-adhesive substance or material. While it is within the scope of the present disclosure for a self-adhesive substance or material 18 (or a component thereof) to be applied to the antenna 10, it may be advantageous for the self-adhesive substance or material 18 to be applied only to the RFID strap 20, as applying a substance or material to the antenna 10 may require controlled printing. Yet, in other embodiments, a self-adhesive substance or material (or a component thereof) may be pattern coated or printed onto the antenna.

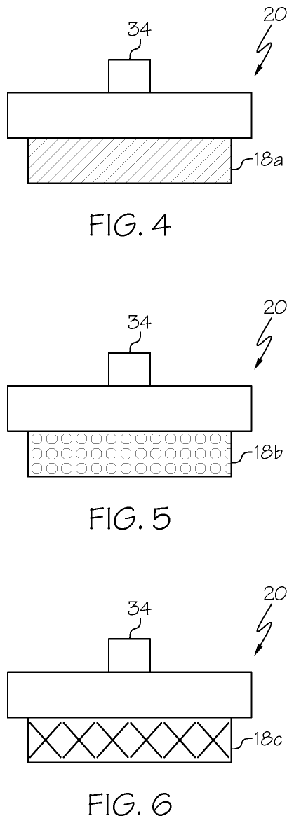

The nature of the self-adhesive substance 18 may vary without departing from the scope of the present disclosure. For example, in one embodiment, the self-adhesive substance 18 is or contains a pressure-sensitive adhesive 18a, as in FIG. 4. In another embodiment, the self-adhesive substance 18 is or contains an isotropic conductive adhesive 18b (as in FIG. 5), which may be configured, for example, as a paste or a film. In yet another embodiment, the self-adhesive substance 18 is or contains an anisotropic conductive adhesive 18c (as in FIG. 6), which may be configured, for example, as a paste or a film. It should be understood the self-adhesive substances or materials shown in FIGS. 4-6 are merely exemplary and that a self-adhesive structure according to the present disclosure may have a different composition without departing from the scope of the present disclosure.

Depending on the nature of the self-adhesive substance or material 18, the RFID strap 20 may be coupled to the antenna 10 by reactance, for example E-field coupling, inductive H-field coupling, or a combination of both. The coupling is a function of the properties of the self-adhesive substance or material 18, such as capacitance being affected by the thickness of the self-adhesive substance or material 18 (i.e., with a doubled thickness resulting in capacitance being reduced by a factor of two). The coupling is also related to the real and imaginary part of the dielectric constant, with a doubling of the real part of the dielectric constant increasing capacitance by a factor of two. The impact of the imaginary part is more complex, however, as an increase is associated with higher loss of RF energy flowing through the material between the antenna pads 12 and 14 and pads of the RFID strap 20 (via the self-adhesive substance or material 18). Accordingly, care should be taken when selecting and applying the self-adhesive substance or material 18 to ensure that it allows for the desired, typically an optimal, performance of the resulting RFID device 22.

The use a self-adhesive substance or material 18 to join the antenna 10 and the RFID strap 20 may have a number advantages. For example, compared to conventional approaches, the assembly process illustrated in FIGS. 1-3 is simplified, as there is no need for a step in which the self-adhesive substance or material 18 is cured (e.g., by application of heat or ultraviolet light) to secure the antenna 10 to the RFID strap 20. By simplifying the assembly procedure, it becomes possible for the RFID device 22 (after manufacture of the RFID strap 20 by an RFID device manufacturer) to be assembled outside of a dedicated RFID device manufacturing factory or facility, including in a factory or facility that is not suitable for the precision processes typically executed (and required) in assembling an RFID device according to conventional approaches. For example, the assembly process illustrated in FIGS. 1-3 may be carried out in a factory or facility primarily intended for manufacture of a product into which the RFID device 22 is to be incorporated, such as a packaging supplier factory.

In addition to the transfer of the components of the RFID device 22 (principally, the RFID strap 20) from the manufacturer to the assembly location, intellectual property, such as antenna designs and attachment methods, may also be transferred to allow for on-site assembly of simplified RFID devices 22. It may be beneficial, for example, for the assembly location to be provided with the tools and know-how required to print conductive ink or to fashion a foil into an antenna (e.g., by punching or cutting the foil), rather than providing the assembly location with finished antennas (although it is also within the scope of the present disclosure for the manufacturer to provide the assembler with formed or finished antennas). In another example, an assembler may be provided with the tools and know-how required to test assembled RFID devices.

The reduction of machine complexity made possible by the RFID devices described herein may also allow for the use of small (e.g., small foot print), possibly mobile “build on demand” systems that can assemble the RFID devices described herein e.g., 22. One or more of such systems may be installed in the facility or factory of the assembler or local to such a facility. Depending on the location in which such a system is installed, it may be provided with a support system, which may include power and data communications, such as a satellite transceiver, if access to such capabilities is not available or reliable in that location. By assembling the RFID devices on-site, there are fewer disadvantages attendant to relocation of the facility or factory of the assembler farther from the factory or facility of an RFID device manufacturer (including increased shipping costs and environmental externalities).

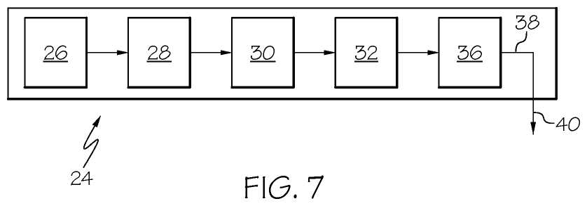

An exemplary “build on demand” system 24 is shown in FIG. 7. The system 24 may be provided with a number of stations at which the different stages of RFID device creation and assembly are carried out, with the system 24 including a mechanism (e.g., a conveyor) to transport an RFID device 22 or a component thereof from one station to the next. For example, an antenna creation station 26 may include the components necessary to form an antenna 10. If the system 24 is provided with an antenna creation station 26, it may be advantageous for the antennas 10 to be digitally defined (i.e., with a pattern that may be changed without physical adjustment to the system 24). Examples of digitally defined antennas would include the ink jet deposition of a conductive ink or a laser system configured to cut a foil material, although other approaches (e.g., selective abrasion) could also be employed. It is also within the scope of the present disclosure for the system 24 to omit an antenna creation station 26, with formed antennas 10 instead being provided to the system 24. However, an antenna creation station 26 may be preferred to provide the assembler with greater flexibility and reduce dependence upon an RFID device manufacturer.

Additional stations of the system 24 could include a strap attach station 28 configured to electrically couple an RFID strap 20 to an antenna 10 by a self-adhesive substance 18, as described above. A testing station 30 positioned downstream of the strap attach station 28, if provided, may be configured to test the performance of an RFID device 22 assembled by the system 24. A programming station 32, if provided, may be configured to program the RFID chip 34 of an RFID device 22 assembled by the system 24. A printing station 36, if provided, may be configured to apply human-readable indicia to an RFID device 22 assembled by the system 24. A cutting station (identified at 38), if provided, may be configured to cut a portion of an RFID device 22 assembled by the system 24, using an X-Y cutter or a laser, for example. An RFID device 22 assembled by the system 24 may be incorporated into a piece of merchandise or the like (e.g., a product tag) after exiting the system 24, as identified at 40. It should be understood that a “build on demand” system according to the present disclosure may be provided with fewer than all of the stations illustrated in FIG. 7 or with additional stations that are not illustrated. Additionally, it should be understood that the various stations of a “build on demand” system according to the present disclosure may be provided in any suitable order (e.g., with a printing station 36 positioned upstream of a programming station 32).

The size and portability of “build on demand” systems may vary, depending on their configuration and functionality. For example, it is contemplated that such a system may be configured to fit inside of a standard shipping container for travel by land and/or sea. In another embodiment, such a system may be configured for easy air freight to assist in rapid movement from one location to another. In yet another embodiment, a “build on demand” system may be provided as a “desktop” unit, being similarly sized to printers already used as part of RFID provision to a product manufacturer for printing variable human readable information.

The present invention contemplates that an RFID manufacturer may prefer to create RFID devices in a large quantity, due to economies of scale. The number of RFID devices preferred to be made by the RFID manufacturer may be greater than the number required by a customer. In one embodiment presently contemplated by the present invention a wet strap construction for an inlay may be created. The present invention contemplates that the adhesive used in correlation with the strap is a pressure sensitive adhesive, but is not limited to such. There are several ways that a wet strap may be constructed. For instance, in one embodiment, in a traditional wet strap construction process, the strap is made using a lead frame, chip adhesive and at least one chip in a chip attach machine. The strap may then be converted into a wet strap by using either 1) a laminating transfer tape and/or 2) applying at least one adhesive with a liner before cutting into individual straps, such as pressure sensitive straps, on a reel.

In another embodiment, presently contemplated for constructing wet straps, the lead frame is first converted in order to first make a wet lead frame. The wet lead frame may be run through a chip attach machine to apply at least one chip adhesive and attach at least one chip to make the finished inlay. This wet first strap method allows for the chip, which has a higher cost compared to the rest of the inlay, to be attached at the end of the manufacturing process thus reducing the risk of damage to the chip and reducing the overall cost of the strap. It is important to note that for both the methods of wet inlay construction briefly mentioned herein, the lead frame can be made either via 1) a traditional etched process, 2) hybrid process which includes at least two cutting steps, one of which may be with a laser and/or 3) with a laser. It is contemplated that the lead frame can be made solely by one of these methods or a combination of the methods mentioned herein.

In another embodiment presently contemplated for wet strap construction, a wet hybrid lead frame process is utilized. This process is similar to a wet first strap method but the lead frames may be flood coating or an adhesive maybe printed on a liner. A conductor laminate, aluminum on PET or paper, may then be laminated, and a bond area (chip gap) is cut. The cutting may be done by a laser, mechanical die cut, or any other way of cutting known in the art. Next, a cross web is cut and the web is slit down to create individual lead frames in a reel. These lead frames may then go, in one embodiment, through a chip attach process. This wet hybrid lead frame process allows for a faster and simpler manufacturing process and a lower tooling and material cost.

It will be understood that the embodiments described above are illustrative of some of the applications of the principles of the present subject matter. Numerous modifications may be made by those skilled in the art without departing from the spirit and scope of the claimed subject matter, including those combinations of features that are individually disclosed or claimed herein. For these reasons, the scope hereof is not limited to the above description but is as set forth in the following claims, and it is understood that claims may be directed to the features hereof, including as combinations of features that are individually disclosed or claimed herein.

1. An RFID device comprising:
an antenna defining a gap; and
an RFID strap electrically coupled to the antenna across the gap, wherein the RFID strap is secured to the antenna by a self-adhesive substance.

2. The RFID device of claim 1, wherein the self-adhesive substance comprises a pressure-sensitive adhesive.

3. The RFID device of claim 1, wherein the self-adhesive substance comprises an isotropic conductive adhesive

4. The RFID device of claim 3, wherein said isotropic conductive adhesive comprises a paste.

5. The RFID device of claim 3, wherein said isotropic conductive adhesive comprises a film.

6. The RFID device of claim 1, wherein the self-adhesive substance comprises an anisotropic conductive adhesive.

7. The RFID device of claim 6, wherein said anisotropic conductive adhesive comprises a paste.

8. The RFID device of claim 6, wherein said anisotropic conductive adhesive comprises a film.

9. A method of assembling an RFID device comprising:
providing an antenna defining a gap;
providing an RFID strap; and
securing the RFID strap to the antenna using a self-adhesive substance so as to electrically couple the RFID strap to the antenna across the gap.

10. The method of claim 9, wherein the self-adhesive substance comprises a pressure-sensitive adhesive.

11. The method of claim 9, wherein the self-adhesive substance comprises an isotropic conductive adhesive

12. The method of claim 11, wherein said isotropic conductive adhesive comprises a paste.

13. The method of claim 11, wherein said isotropic conductive adhesive comprises a film.

14. The method of claim 9, wherein the self-adhesive substance comprises an anisotropic conductive adhesive.

15. The method of claim 14, wherein said anisotropic conductive adhesive comprises a paste.

16. The method of claim 14, wherein said anisotropic conductive adhesive comprises a film.

17. A system for assembling an RFID device, comprising:
an antenna creation station configured to form an antenna defining a gap; and
a strap attach station configured to electrically couple an RFID strap to the antenna across the gap, wherein the RFID strap is secured to the antenna by a self-adhesive substance.

18. The system of claim 17, further comprising a testing station configured to test the performance of an RFID device assembled by the system.

19. The system of claim 17, further comprising a programming station configured to program an RFID chip of an RFID device assembled by the system.

20. The system of claim 17, further comprising a printing station configured to apply human-readable indicia to an RFID device assembled by the system.

21. The system of claim 17, further comprising a cutting station configured to cut a portion of an RFID device assembled by the system.
